(19) United States
(12) Patent Application Publication
(10) Pub. No.: US 2011/0303305 A1
(43) Pub. Date: Dec. 15, 2011

(54) FAUCET ASSEMBLY

(76) Inventor: Andy Chen, Taichung (TW)

(21) Appl. No.: 12/814,620

(22) Filed: Jun. 14, 2010

(51) Int. Cl. E03C 1/044; F16K 49/00; F16K 11/22

(52) U.S. Cl. 137/334; 137/603; 137/897; 137/606; 137/801

(57) ABSTRACT

A faucet assembly includes a faucet body, a pipe unit and a control unit. The pipe unit is disposed outside the faucet body. The pipe unit uses an inlet pipe, a junction pipe and an outlet pipe to complete the pipe configuration of the faucet body. It is easy to manufacture the faucet of the present invention. To assemble the faucet of the present invention, the user can connect the relative pipes with ease.

### BACKGROUND OF THE INVENTION

1. Field of the Invention

The present invention relates to a faucet assembly.

2. Description of the Prior Art

As shown in FIG. 1 and FIG. 2, a conventional faucet structure comprises a faucet base 1. The faucet base 1 includes a cold water control 2, a hot water control 3, and a main outlet pipe 4. A first inlet pipe 5 is to connect a water supply and the cold water control 2. A first outlet pipe 6 is to connect the cold water control 2 and the main outlet pipe 4. A second inlet pipe 7 is to connect the water supply and the hot water control 3. A second outlet pipe 8 is to connect the hot water control 3 and the main outlet pipe 4. The second outlet pipe 8 is further connected with a heating device 9 for heating cold water to be hot water. When in use, the cold water control 2 is used to control the cold water to flow through the main outlet pipe 4, and the hot water control 3 is used to control the hot water to flow through the main outlet pipe 4. However, the space in the faucet base 1 is not enough. To install the main outlet pipe 4, the first inlet pipe 5, the first outlet pipe 6, the second inlet pipe 7 and the second outlet pipe 8 in the faucet base 1 is somewhat crowded. This causes a difficulty in manufacturing the faucet. Besides, it is not easy for the user to connect so many pipes. To install this faucet takes a lot of time and is inconvenient. Accordingly, the inventor of the present invention has devoted himself based on his many years of practical experiences to solve this problem.

### SUMMARY OF THE INVENTION

The present invention is to provide a faucet assembly which comprises a faucet body, a pipe unit and a control unit. The faucet body comprises an installation portion and an outlet portion at two ends thereof. The faucet body has an outer wall formed with a first fixing hole and a second fixing hole. The faucet body has an inlet passage, a first outlet passage and a main passage. The inlet passage communicates with the first fixing hole and the second fixing hole. The first outlet passage communicates with the first fixing hole. The main passage passes through the installation portion and the outlet portion. The installation portion has an inlet to communicate with the main passage. The outlet portion has an outlet to communicate with the main passage. The faucet body further has a second outlet passage. Two ends of the second outlet passage is connected with the second fixing hole and the main passage respectively, so that the inlet passage communicates with the main passage. The pipe unit comprises an inlet pipe, a junction pipe and an outlet pipe. One end of the inlet pipe is connected to a water supply and another end of the inlet pipe is connected to the inlet passage. One end of the junction pipe is connected to the first outlet passage and another end of the junction pipe is connected to a water inlet of a temperature adjuster. One end of the outlet pipe is connected to a water outlet of the temperature adjuster and another end of the outlet pipe is connected to the main passage through the inlet of the faucet body and fixed at the outlet. A gap is defined between the outlet pipe and an inner wall of the main passage to form a third outlet passage. The control unit comprises a first control and a second control. The first control is disposed at the first fixing hole for controlling water from the water supply to enter the inlet passage and flow to the first outlet passage. The second control is disposed at the second fixing hole for controlling water from the water supply to enter the inlet passage and flow to the second outlet passage. Thereby, the user only needs to connect the pipes outside the faucet body to complete the assembly of the entire faucet. Compared to the conventional faucet having all the pipes in the faucet base, the present invention can be assembled easily. Besides, it is easy to manufacture the faucet of the present invention so as lower the cost. Through the simplified pipes, the pipe unit only has the inlet pipe, the junction pipe and the outlet pipe, so that the user can connect the relative pipes with ease.

### BRIEF DESCRIPTION OF THE DRAWINGS

FIG. 1 is a perspective view of a conventional faucet;

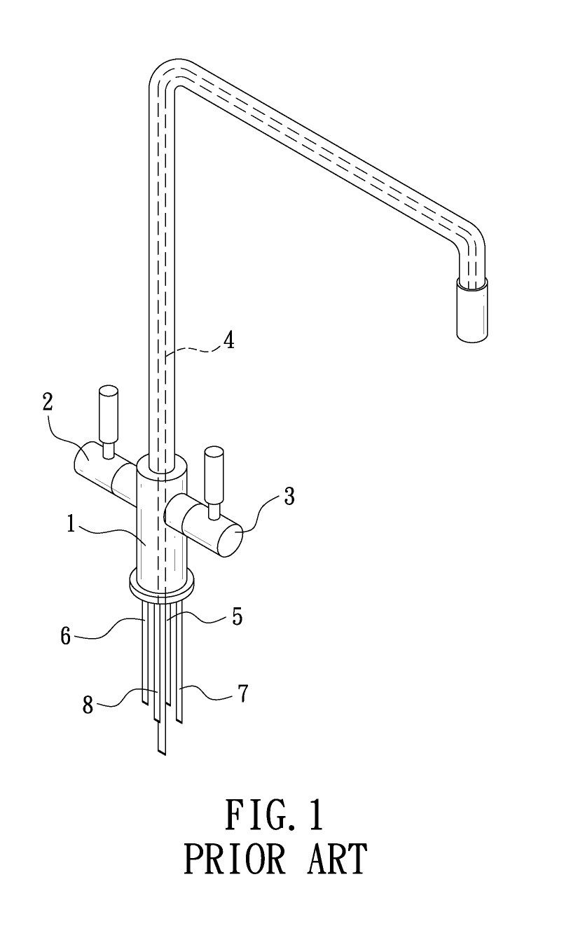

FIG. 2 is a diagram to show the connection of pipes in the conventional faucet;

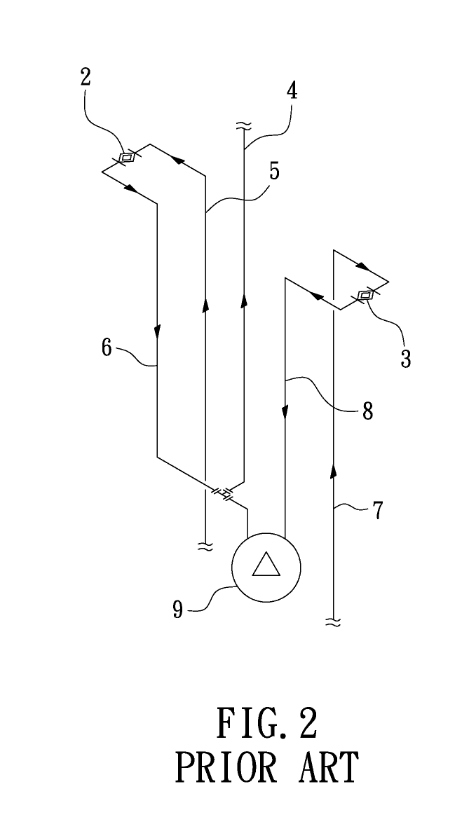

FIG. 3 is a perspective view in accordance with a preferred embodiment of the present invention;

FIG. 4 is an exploded view of a facet body in accordance with the preferred embodiment of the present invention;

FIG. 5 is a cross-sectional view of the faucet body in accordance with the preferred embodiment of the present invention;

FIG. 6 is a partially enlarged and cross-sectional view in accordance with the faucet body of the preferred embodiment of the present invention; and

FIG. 7 is a diagram to show the connection of pipes in accordance with the preferred embodiment of the present invention.

### DETAILED DESCRIPTION OF THE PREFERRED EMBODIMENTS

Embodiments of the present invention will now be described, by way of example only, with reference to the accompanying drawings.

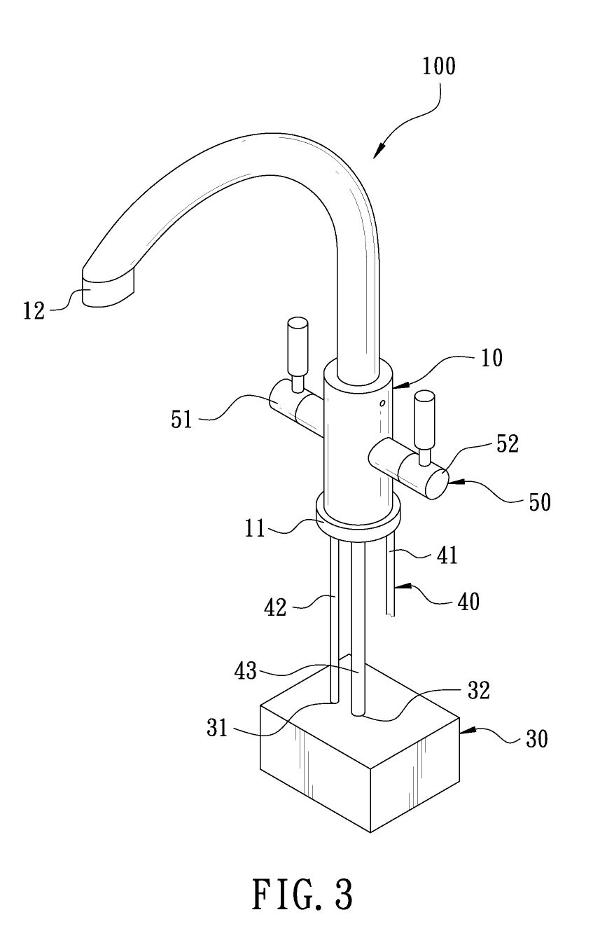

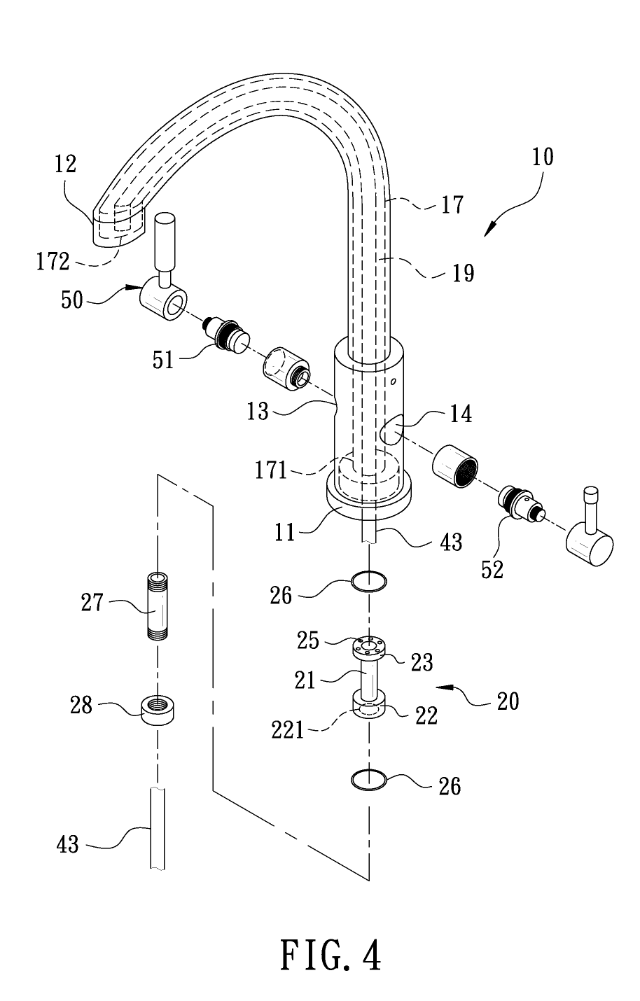

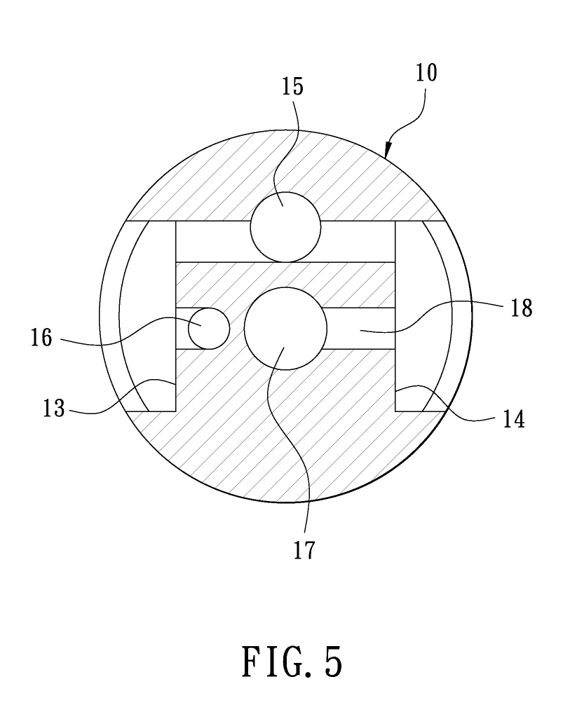

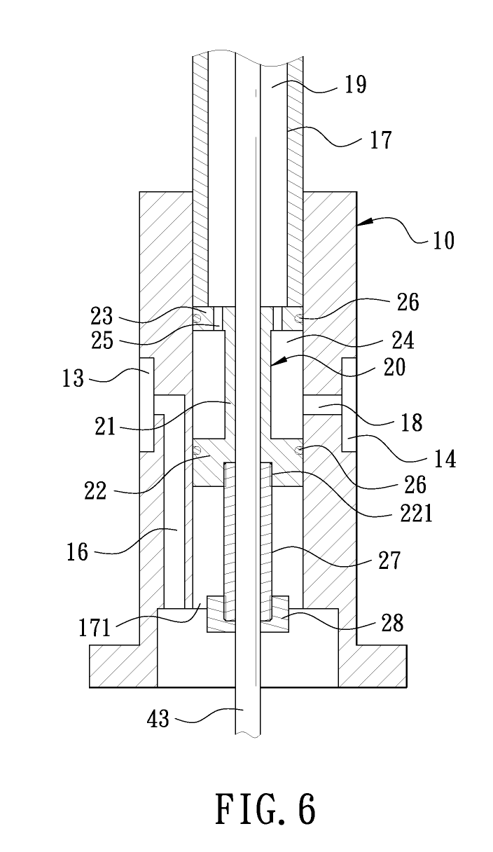

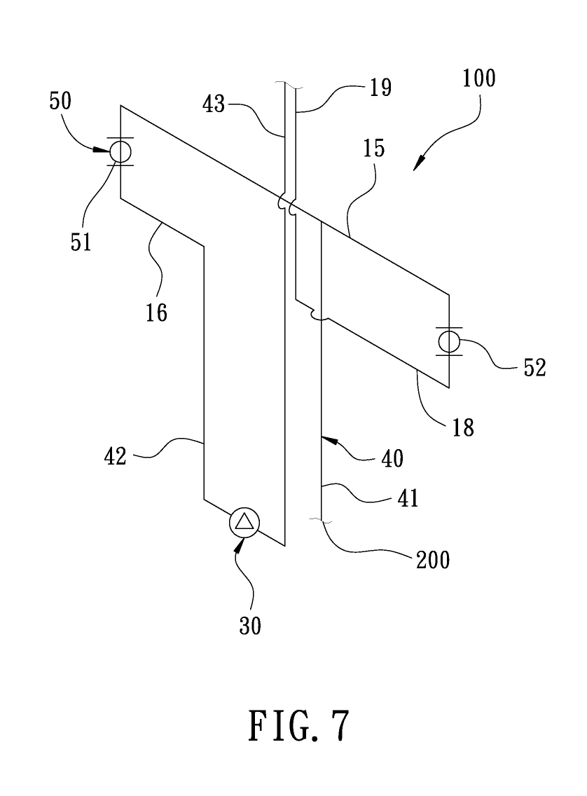

As shown in FIGS. 3 to 7, a faucet assembly 100 according to a preferred embodiment of the present invention comprises a faucet body 10, a retaining base 20, a temperature adjuster 30, a pipe unit 40, and a control unit 50.

The faucet body 10 comprises an installation portion 11 and an outlet portion 12 at two ends thereof. The faucet body 10 has an outer wall formed with a first fixing hole 13 and a second fixing hole 14. The faucet body 10 has an inlet passage 15, a first outlet passage 16 and a main passage 17. The inlet passage 15 communicates with the first fixing hole 13 and the second fixing hole 14. The first outlet passage 16 communicates with the first fixing hole 13. The main passage 17 passes through the installation portion 11 and the outlet portion 12. The installation portion 11 has an inlet 171 to communicate with the main passage 17. The outlet portion 12 has an outlet 172 to communicate with the main passage 17. The faucet body 10 further has a second outlet passage 18. Two ends of the second outlet passage 18 are connected with the second fixing hole 14 and the main passage 17, respectively, so that the inlet passage 15 communicates with the main passage 17.

The retaining base 20 is disposed at the joint of the main passage 17 of the faucet body 10 and the second outlet passage 18. In this embodiment, the retaining base 20 has a hollow pipe 21. The hollow pipe 21 has a diameter smaller than that of the main passage 17. The hollow pipe 21 is laterally provided with a first retaining portion 22 at one end close to the inlet 171 and a second retaining portion 23 at another end thereof. The first retaining portion 22 and the second retaining portion 23 are against an inner wall of the main passage 17, such that a chamber 24 is formed between the first retaining portion 22 and the second retaining portion 23. The chamber 24 communicates with the second outlet passage 18. The second retaining portion 23 has a plurality of through holes 25 to communicate with the chamber 24, so that the chamber 24 can communicate with the main passage 17. The first retaining portion 22 is provided with an O-shaped ring 26 on an outer wall thereof, and the second retaining portion 23 is also provided with an O-shaped ring 26 on an outer wall thereof to prevent leakage. The first retaining portion 22 has a locking hole 221 opposite to the second retaining portion 23. The locking hole 221 is adapted to connect with a hollow metallic pipe 27. The hollow metallic pipe 27 is further connected with an annular block 28 to enhance the leakage effect.

The temperature adjuster 30 can be a heating device or a refrigeration device disposed close to the faucet body 10. The temperature adjuster 30 has a water inlet 31 and a water outlet 32.

The pipe unit 40 comprises an inlet pipe 41, a junction pipe 42 and an outlet pipe 43. One end of the inlet pipe 41 is connected to a water supply 200, and another end of the inlet pipe 41 is connected to the inlet passage 15. One end of the junction pipe 42 is connected to the first outlet passage 16, and another end of the junction pipe 42 is connected to the water inlet 31 of the temperature adjuster 30. The outlet pipe 43 is made of silica gel. One end of the outlet pipe 43 is connected to the water outlet 32 of the temperature adjuster 30, and another end of the outlet pipe 43 is connected to the main passage 17 through the inlet 171 of the faucet body 10 and fixed at the outlet 172. In this embodiment, the outlet pipe 43 is first inserted through the hollow metallic pipe 27 and the hollow pipe 21 to enter into the main passage 17 and then fixed at the outlet 172. A gap 17 is defined between the outlet pipe 43 and the inner wall of the main passage 17 to form a third outlet passage 19.

The control unit 50 comprises a first control 51 and a second control 52. The first control 51 is disposed at the first fixing hole 13 for controlling the water from the water supply 200 to enter the inlet passage 15 and flow to the first outlet passage 16. The second control 52 is disposed at the second fixing hole 14 for controlling the water from the water supply 200 to enter the inlet passage 15 and flow to the second outlet passage 18.

Referring to the drawings, the faucet body 10 is preset with the inlet passage 15, the first outlet passage 16, the main passage 17 and the second outlet passage 18. To assemble the present invention, the two ends of the inlet pipe 41 are connected to the water supply 20 and the inlet passage 15, respectively. The two ends of the junction pipe 42 are connected to the first outlet passage 16 and the water inlet 31 of the temperature adjuster 30, respectively. The outlet pipe 43 is connected to the water outlet 32 of the temperature adjuster 30. The assembly of the present invention is completed. Compared to the conventional faucet having all the pipes in the faucet base, the present invention can be assembled easily. Besides, it is easy to manufacture the faucet of the present invention so as lower the cost. After installation, the user can turn the second control 52 for cold water as desired, the cold water from the water supply 200 will flow through the inlet pipe 41 and the outlet passage 18 to the chamber 24, and then enter the third outlet passage 19 through the through holes 25, and finally flow out through the outlet 172. The user can turn the first control 51 for hot water or icy water as desired, the cold water from the water supply 200 will flow through the inlet pipe 41 and the junction pipe 42 to be heated or refrigerated by the temperature adjuster 30, and then flow out through the outlet pipe 43. When the temperature adjuster 30 is a heating device, the temperature adjuster 30 is disposed outside the faucet body 10 and the outlet pipe 43 is made of silica gel to isolate the hot water effectively. The energy of the hot water won't be transferred to the faucet body 10 by heat conduction, preventing the user from being scalded. By the third outlet passage 19 between the outlet pipe 43 and the main passage 17, the cold water flows through the third outlet passage 19 to lower the temperature of the outlet pipe 43 and the faucet body 10, achieving a better effect to guard against scald.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A faucet assembly, comprising:
a faucet body comprising an installation portion and an outlet portion at two ends thereof, the faucet body having an outer wall formed with a first fixing hole and a second fixing hole, the faucet body having an inlet passage, a first outlet passage and a main passage, the inlet passage communicating with the first fixing hole and the second fixing hole, the first outlet passage communicating with the first fixing hole, the main passage passing through the installation portion and the outlet portion, the installation portion having an inlet to communicate with the main passage, the outlet portion having an outlet to communicate with the main passage, the faucet body further having a second outlet passage, two ends of the second outlet passage being connected with the second fixing hole and the main passage respectively, so that the inlet passage communicating with the main passage;
a pipe unit comprising an inlet pipe, a junction pipe and an outlet pipe, one end of the inlet pipe being connected to a water supply and another end of the inlet pipe being connected to the inlet passage, one end of the junction pipe being connected to the first outlet passage and another end of the junction pipe being connected to a water inlet of a temperature adjuster, one end of the outlet pipe being connected to a water outlet of the temperature adjuster and another end of the outlet pipe being connected to the main passage through the inlet of the faucet body and fixed at the outlet, a gap being defined between the outlet pipe and an inner wall of the main passage to form a third outlet passage; and
a control unit comprising a first control and a second control, the first control being disposed at the first fixing hole for controlling water from the water supply to enter the inlet passage and flow to the first outlet passage, the second control being disposed at the second fixing hole for controlling water from the water supply to enter the inlet passage and flow to the second outlet passage.

2. The faucet assembly as claimed in claim 1, wherein the faucet body further comprises a retaining base at the joint of the main passage and the second outlet passage, the retaining base having a hollow pipe, the hollow pipe having a diameter smaller than that of the main passage, the hollow pipe being laterally provided with a first retaining portion at one end close to the inlet and a second retaining portion at another end thereof, the first retaining portion and the second retaining portion being against the inner wall of the main passage so that a chamber being formed between the first retaining portion and the second retaining portion, the chamber communicating with the second outlet passage, the second retaining portion having a plurality of through holes to communicate with the chamber.

3. The faucet assembly as claimed in claim 2, wherein the first retaining portion is provided with an O-shaped ring on an outer wall thereof and the second retaining portion is provided with an O-shaped ring on an outer wall thereof.

4. The faucet assembly as claimed in claim 2, wherein the first retaining portion has a locking hole opposite to the second retaining portion, the locking hole being adapted to connect with a hollow metallic pipe, the hollow metallic pipe being further connected with an annular block.

5. The faucet assembly as claimed in claim 1, wherein the outlet pipe is made of silica gel.

6. The faucet assembly as claimed in claim 1, wherein the temperature adjuster is a heating device.

7. The faucet assembly as claimed in claim 1, wherein the temperature adjuster is a refrigeration device.
